(19) United States
(12) Patent Application Publication
(10) Pub. No.: US 2026/0263896 A1
(43) Pub. Date: Sep. 10, 2026

(54) PORTABLE GREEN INFORMATION PROVIDING DEVICE FOR PROVIDING LINE INFORMATION OF GOLF GREEN AREA

(71) Applicant: Chang-Ju Lee, Seoul (KR)

(72) Inventor: Chang-Ju LEE, Seoul (KR)

(21) Appl. No.: 19/558,361

(22) Filed: Mar. 5, 2026

(30) Foreign Application Priority Data
Mar. 7, 2025 (KR) 10-2025-0029435

(51) Int. Cl. A63B 71/06

(52) U.S. Cl. CPC A63B 71/0622; A63B 2220/805; A63B 2220/807

(57) ABSTRACT

A portable green information providing device includes: a camera configured to capture a golf green area, generate a two-dimensional image of the golf green area, and recognize positions of a golf ball and a hole cup; and a three-dimensional depth image sensor configured to scan the golf green area and generate three-dimensional depth image data of the golf green area. With a capturing direction of the camera and a scan direction of the three-dimensional depth image sensor being spatially aligned, the two-dimensional image of the golf green area from the camera and the three-dimensional depth image data of the golf green area from the three-dimensional depth image sensor are mapped to generate corrected green information, and a distance value between the golf ball and the hole cup and a slope between the golf ball and the hole cup are displayed on an electronic display.

### CROSS REFERENCE TO RELATED APPLICATION

This application claims priority to and the benefit of Korean Patent Application No. 10-2025-0029435, filed on March 7, 2025, in the Korean Intellectual Property Office, the entire content of which is incorporated herein by reference.

### BACKGROUND

### 1. Technical Field

The present disclosure relates to a portable green information providing device for providing line information of a golf green area at a golf course.

### 2. Description of the Related Art

As the number of amateur golfers taking up and enjoying the game continues to grow, the market for golf equipment and accessories has expanded accordingly. In response, portable terminal devices capable of providing golf course line condition information—such as distance data—have been developed and commercialized in various forms.

Amateur golfers have historically relied on caddies to obtain information about the line conditions of a golf course. However, as the number of amateur golfers who play without caddies has increased, conventional golf assistance terminals may be insufficient to obtain accurate line condition information. In particular, if accurate and precise line condition information for the green area of a golf course is not available, amateur golfers may lose confidence in their putting and, as a result, may lose interest in the game altogether.

Accordingly, there exists a need for a device that provides accurate and precise line condition information for the green area of a golf course, thereby enabling golfers to improve their putting skills and maintain their interest in the game.

Korean Registered Patent Publication No. 10-1841172 (entitled "Mobile Terminal for Providing Golf Putting Line Information Using LiDAR") discloses a technology including: a green detection LiDAR sensor unit attached to at least one surface of a mobile terminal, configured to sense a golf course green and generate a three-dimensional (3D) green image; and a camera unit formed on at least one surface of the mobile terminal, configured to photograph the golf green and enable a controller to acquire position information of a golf ball and a hole cup. This technology simulates the movement of a golf ball using position information of the golf ball and the hole cup on a 3D green model that includes elevation and slope information, and displays an optimal putting trajectory. However, since most domestic and international golf courses do not disclose green information, this approach does not function at golf courses where such green information is unavailable.

Furthermore, as disclosed in the invention of Korean Patent Application No. 10-2024-0202399 (entitled "Portable Green Information Providing Device") filed by the present applicant, when implementing a portable device that recognizes a golf ball and a hole cup using LiDAR, there are drawbacks including degraded recognition accuracy at long distances and limitations imposed by battery capacity, which reduce the reliability of the green information. Additionally, novice users may need to review measurement results multiple times; for example, a novice user may have to activate the LiDAR sensor and then manually verify on the display whether the hole cup and the golf ball are properly shown, which can be inconvenient.

### SUMMARY

The present disclosure has been made to address the foregoing problems, and an object of the present disclosure is to accurately and precisely provide, on an electronic display, line condition information for a golf green area, thereby enhancing the putting ability and interest of golfers.

A further object of the present disclosure is to accurately and precisely provide line condition information for a golf green area even at a golf course green for which no green map information is available.

In accordance with one aspect of the present disclosure, with a capturing direction of a camera and a scan direction of a three-dimensional depth image sensor being spatially aligned, a two-dimensional image of a golf green area from the camera and three-dimensional depth image data of the golf green area from the three-dimensional depth image sensor are mapped to generate corrected green information, and a distance value between a golf ball and a hole cup and a slope between the golf ball and the hole cup are displayed on an electronic display.

In accordance with an additional aspect of the present disclosure, a timing at which the camera recognizes the positions of the golf ball and the hole cup and a timing at which the three-dimensional depth image sensor recognizes the positions of the golf ball and the hole cup are controlled to be synchronized.

In accordance with the present disclosure, line condition information for a golf green area is accurately and precisely provided, thereby improving the putting ability of golfers and enhancing their enjoyment of the game.

The present disclosure complements the characteristics of a camera—which excels at recognizing distant objects but has difficulty measuring precise distances—with the characteristics of a three-dimensional depth image sensor (e.g., LiDAR), which is capable of accurate distance and slope measurement but has limited ability to recognize small objects and objects at long range, thereby providing an optimal device configuration.

Power consumption of the three-dimensional depth image sensor is minimized, thereby extending the operating time of the portable green information providing device.

### BRIEF DESCRIPTION OF THE DRAWINGS

FIG. 1 illustrates an external appearance of a portable green information providing device according to an embodiment.

FIG. 2 is a block diagram illustrating a configuration of a portable green information providing device according to an embodiment.

FIG. 3 is a flowchart illustrating spatial calibration according to an embodiment.

FIG. 4 illustrates an electronic display that is spatially aligned with a field of view aimed by a three-dimensional depth image sensor and displays a two-dimensional image, according to an embodiment.

FIG. 5 illustrates an electronic display showing line information of a golf green area in which a golf ball and a hole cup are disposed, according to an embodiment.

FIG. 6 illustrates a method of synchronizing a snapshot operation of a camera and a scanning operation of a three-dimensional depth image sensor according to an embodiment. FIG. 6(A) illustrates a synchronization method in which a time at which the snapshot operation of the camera starts is identical to a time at which the scanning operation of the three-dimensional depth image sensor starts. FIG. 6(B) illustrates a synchronization method in which the time at which the snapshot operation of the camera starts is later than the time at which the scanning operation of the three-dimensional depth image sensor starts.

FIG. 7 illustrates an electronic display showing a virtual scan button according to an embodiment.

FIG. 8 illustrates an electronic display additionally showing a virtual ball marker according to an embodiment.

FIG. 9 illustrates an electronic display additionally showing a plurality of virtual ball markers according to another embodiment.

FIG. 10 illustrates an electronic display additionally showing a simulation button and a virtual trajectory of a golf ball according to an embodiment.

FIG. 11 is a block diagram illustrating a configuration of a portable green information providing device according to another embodiment.

FIG. 12 is a block diagram illustrating a configuration of a computing unit according to an embodiment.

FIG. 13 illustrates a plurality of points recognized by a point recognizer according to an embodiment.

### DETAILED DESCRIPTION OF THE EMBODIMENTS

The foregoing and additional aspects are embodied through the embodiments described below with reference to the accompanying drawings. The constituent elements of the respective embodiments are understood to be combinable within an embodiment or with constituent elements of other embodiments in various ways, unless otherwise stated or a contradiction arises therebetween. On the principle that the inventor may appropriately define the concept of a term in order to describe the invention in the best manner, the terms used in the present specification and claims should be interpreted as having meanings and concepts consistent with the described content or the proposed technical idea. Preferred embodiments of the present invention will now be described in detail with reference to the accompanying drawings.

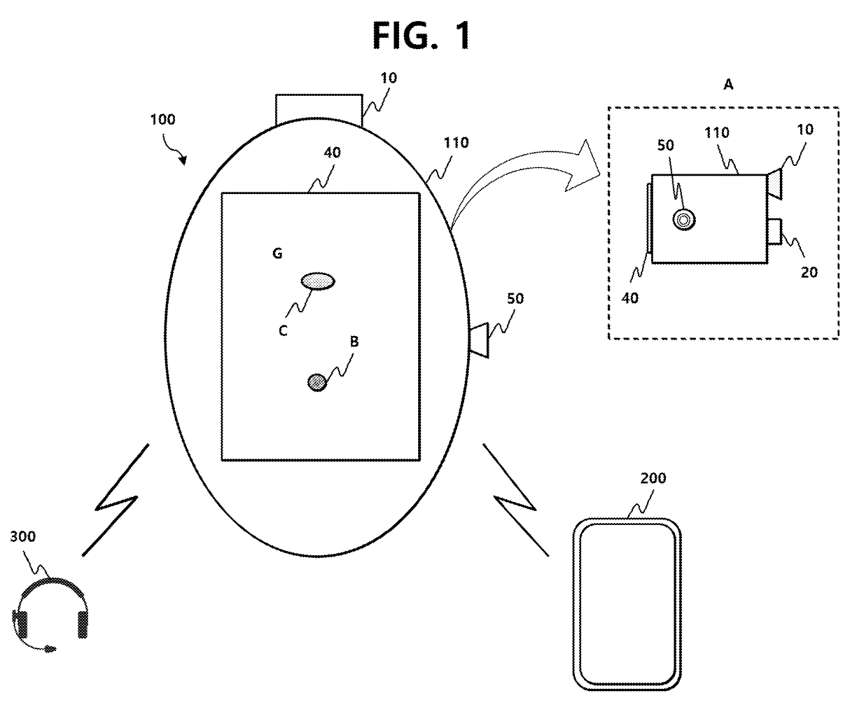

FIG. 1 illustrates an external appearance of a portable green information providing device 100 according to an embodiment. As illustrated, the portable green information providing device 100 includes a camera 10, a three-dimensional depth image sensor 20, and an electronic display 40, and may further include a speaker 50.

The electronic display 40 may visually display a golf green area G of a golf course, a hole cup C, and a golf ball B. The electronic display 40 may be implemented as a monitor having a rectangular shape extending in the up-down direction so that the hole cup C and the golf ball B can be simultaneously displayed facing forward. The electronic display 40 may be implemented using various technologies such as OLED, LCD, AMOLED, and the like.

The camera 10, the three-dimensional depth image sensor 20, the electronic display 40, and the speaker 50 may be at least partially provided on and supported by a body 110. The portable green information providing device 100 may perform data communication with an external smartphone 200 or earset 300.

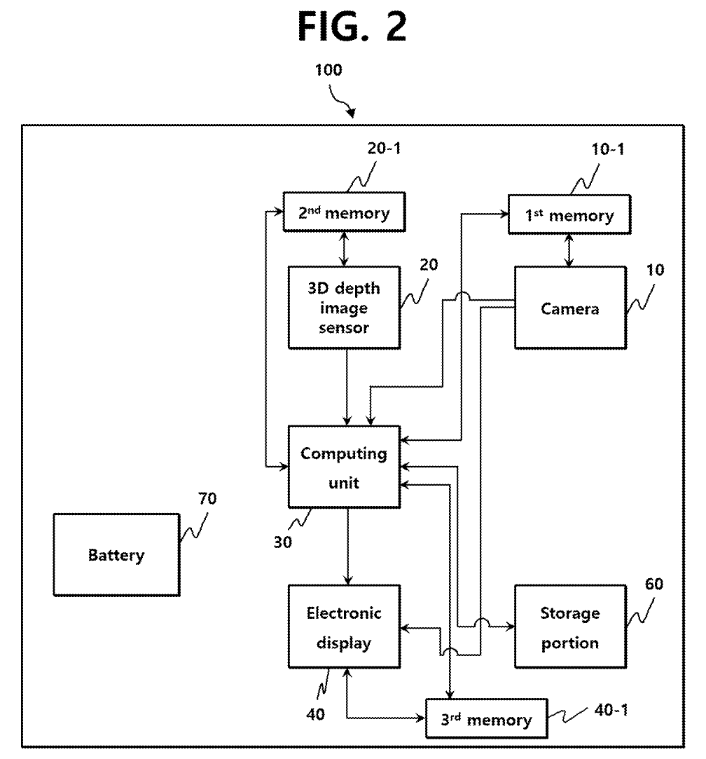

FIG. 2 is a block diagram illustrating a configuration of the portable green information providing device 100 according to an embodiment. FIG. 2 shows a camera 10, a three-dimensional depth image sensor 20, a computing unit 30, an electronic display 40, a first memory 10-1, a second memory 20-1, a third memory 40-1, a storage 60, and a battery 70.

According to an embodiment, the portable green information providing device 100 for providing line information of a golf green area in which a golf ball and a hole cup are disposed includes the camera 10, the three-dimensional depth image sensor 20, the computing unit 30, and the electronic display 40, and is configured to accurately and precisely provide line condition information for the golf green area. According to one aspect, the portable green information providing device 100 may be integrated with a general golf rangefinder terminal that is widely used for measuring the position of a golfer and the position and distance of a flagstick using a laser.

The green area G refers to a portion of the golf course extending to a certain distance centered on the hole cup, and may encompass an area broader than what is generally referred to as "the green."

The camera 10 captures the golf green area, generates a two-dimensional image of the golf green area, and recognizes the positions of the golf ball and the hole cup. According to an embodiment, the camera 10 may include an artificial intelligence (AI) engine and may recognize the positions of the golf ball and the hole cup using an AI or deep learning algorithm. For example, the camera 10 may recognize the positions of the golf ball and the hole cup using at least one of AI algorithms such as a Convolutional Neural Network (CNN), a Recurrent Neural Network (RNN), a Multi-Layer Perceptron (MLP), and a Random Forest.

According to an embodiment, the camera 10 may compare data distances between images of the hole cup and the golf ball in the golf green area and images of other objects (e.g., leaves, birds, grass, flowers), classify the images according to predefined categories (Classification), recognize boundaries or center points of the hole cup and the golf ball (Detection), and segment images of the hole cup and the golf ball from images of other objects (Segmentation) to recognize the hole cup and the golf ball and further recognize their positions. The region of the hole cup and the golf ball recognized through segmentation processing may be set to a region somewhat larger than the actual region. This expands the range of positions of the golf ball and the hole cup recognized by the three-dimensional depth image sensor 20, which will be described below, thereby improving the reliability of the three-dimensional depth image data. The classification may further distinguish between the hole cup and the golf ball. For example, an object positioned in the foreground may be recognized as the golf ball, and an object positioned in the background may be recognized as the hole cup.

The three-dimensional depth image sensor 20 scans the golf green area and generates three-dimensional depth image data of the golf green area. The three-dimensional depth image sensor 20 irradiates light or electromagnetic waves onto the golf green area G and detects the time of reflected light or electromagnetic waves, thereby generating three-dimensional (3D) depth image data of the golf course green area. As another example, the three-dimensional depth image sensor 20 may be a Time-of-Flight (ToF) sensor. Although current ToF sensors cover only approximately 2 to 3 meters, they may be applied when they become capable of providing precise depth images up to the distance required for implementation of the present disclosure—for example, up to approximately 15 meters.

According to an embodiment, the camera 10 captures the golf green area that is spatially calibrated with the golf green area captured by the three-dimensional depth image sensor, and generates a two-dimensional image of the golf green area. The coordinate system of the camera 10 and the coordinate system of the three-dimensional depth image sensor 20 may be integrated so that the viewing direction of the camera and the viewing direction of the three-dimensional depth image sensor 20 coincide.

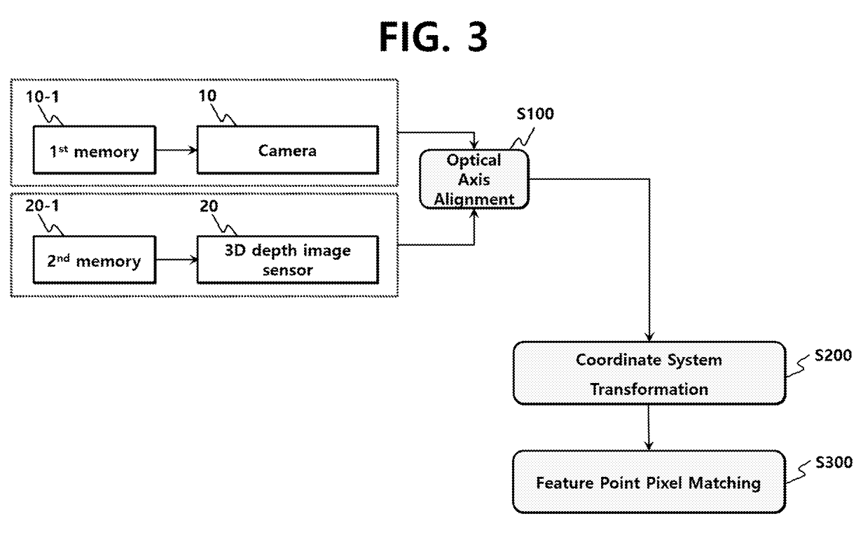

FIG. 3 is a flowchart illustrating spatial calibration according to an embodiment. During the manufacturing process of the portable green information providing device 100, spatial calibration may be performed. Correction parameter values (internal parameter values and external parameter values) for the camera 10 itself may be stored in the first memory 10-1, and similarly, correction parameter values (internal parameter values and external parameter values) for the three-dimensional depth image sensor 20 itself may be stored in the second memory 20-1. Distortion between pixels may be corrected through a software-based correction table. During the manufacturing process, correction parameters of a correction matrix for each pixel are stored in the correction table, and during operation, calculations may be processed from pixel coordinates using this correction table.

In this state, optical axis alignment (S100) may be performed between the camera 10 and the three-dimensional depth image sensor 20. The optical axis alignment (S100) may determine the physical arrangement relationship between the camera 10 and the three-dimensional depth image sensor 20, such as the physical distance and angle therebetween, to predetermined values.

Subsequently, the pixel coordinate system of the image captured by the camera 10 and the pixel coordinate system of the depth image captured by the three-dimensional depth image sensor 20 may be aligned with each other. For example, as illustrated in FIG. 3, the coordinate system of the 3D depth image sensor 20 may be transformed to the coordinate system of the camera 10 (S200), and feature points of the coordinate system of the 3D depth image sensor 20 may be mapped to the coordinate system of the camera 10 for alignment. The above mapping may be performed by matching pixels of the 3D depth image sensor 20 to pixels of the camera 10 and further storing this matching information in the first memory 10-1. The first memory 10-1 and the second memory 20-1 may each comprise a plurality of memory cells arranged in an array.

Through the optical axis alignment (S100) and feature point pixel matching (S300) steps, the camera 10 can acquire data transformed in an integrated coordinate system that integrates the pixel space (coordinate system) of the three-dimensional depth image sensor 20 and the pixel space (coordinate system) of the camera 10. As a result, the portable green information providing device 100 can configure the camera 10 to have a field of view (FOV) that covers the same range as the FOV of the three-dimensional depth image sensor 20. In this coordinate transformation process, coordinates of a real-space coordinate system based on the surface of the earth may be calculated, and for this purpose, an Earth center direction vector may need to be determined. The camera 10 may include therein a camera image sensor (not shown) comprising a plurality of pixels.

According to an additional embodiment, the spatial calibration may further include a step of further transforming the coordinate system of the camera 10 to the coordinate system of the electronic display 40 using the third memory 40-1; however, a detailed description thereof is omitted.

The computing unit 30 may control generation of mapped golf green area information by spatially mapping the two-dimensional image from the camera 10 with the three-dimensional depth image data from the three-dimensional depth image sensor. The computing unit 30 may be configured as a microprocessor. During use of the portable green information providing device 100 by a user, the computing unit 30 may control generation of spatially mapped golf green area information from the three-dimensional depth image data acquired from the three-dimensional depth image sensor 20 using the calibration information stored in the first memory 10-1. The mapped golf green area information may be generated as a display frame and displayed by the electronic display 40.

The electronic display 40 displays the mapped golf green area information as a two-dimensional image. The electronic display 40 may visually display the green area G, the hole cup C, and the golf ball B of the golf course. The electronic display 40 may be implemented as a monitor having a rectangular shape extending in the up-down direction so that the hole cup C and the golf ball B can be simultaneously displayed facing forward. The electronic display 40 may be implemented using various technologies such as OLED, LCD, and the like.

The electronic display 40 may convert data sensed by the three-dimensional depth image sensor 20 into a two-dimensional image and display it on the display. This image is aligned with the three-dimensional depth image data generated by the three-dimensional depth image sensor 20, and the sensed images of the hole cup and the golf ball may be displayed at corresponding positions. Through this, information about the green surface sensed by the actual device can be visually provided to the user, and the user can manipulate the device while viewing the electronic display 40 to position the device at an appropriate location on the screen.

The storage 60 stores a computer program for the computing unit 30 to perform a series of functions. The battery 70 is electrically connected to the components of the portable green information providing device (not shown) and supplies power to each component. At least one of the first memory 10-1, the second memory 20-1, the third memory 40-1, and the storage 60 may be configured as a non-volatile memory, but is not limited thereto. According to an embodiment, the first memory 10-1 may be integrated with the camera 10, the second memory 20-1 with the three-dimensional depth image sensor 20, and the third memory 40-1 with the electronic display 40 as respective single modules, but this is not necessarily required. When a user does not use the portable green information providing device 100 for a predetermined period of time, it may automatically switch to a sleep mode, and when a specific input button is pressed in the sleep mode, it may switch to a wake-up mode, thereby conserving battery power.

According to an embodiment, the three-dimensional depth image sensor 20 may be a LiDAR (Light Detection And Ranging) sensor. A LiDAR sensor outputs a high-power laser pulse signal, receives a signal reflected from an object, and measures the time of flight, thereby generating 3D or 4D spatial information such as distance, position, or shape-related data. The LiDAR sensor may be a sensor constituting MEMS or Flash solid-state 3D LiDAR.

LiDAR has the advantage of accurately recognizing the shape of objects at close range and exhibiting high positional precision compared to other signals such as radar, along with fast scanning speed; however, it also has the disadvantage of high energy consumption.

According to an embodiment, the computing unit 30 may determine three-dimensional depth image data corresponding to regions in the two-dimensional image where the recognized golf ball and hole cup positions are located, and process the three-dimensional depth image data of the determined regions. The computing unit 30 may search for the hole cup and the golf ball within the positions of the golf ball and the hole cup recognized by the camera, or within a region of a certain distance covering those positions. Recognition of the positions of the golf ball and the hole cup may be performed preferentially by the camera 10. The computing unit 30 may acquire three-dimensional depth image data collected in these position regions and calculate a distance value between the golf ball and the hole cup and a slope between the golf ball and the hole cup. This enables overcoming the limitation of the recognition or search capability of the three-dimensional depth image sensor 20, and enables fast and accurate searching.

According to an embodiment of an additional aspect, the computing unit 30 may further calculate at least a distance value between the golf ball and the hole cup and a slope between the golf ball and the hole cup, further based on position information of the golf ball and the hole cup acquired from the three-dimensional depth image sensor 20. That is, since the recognition or search capability of the three-dimensional depth image sensor 20 may be excellent at close range within approximately 15 meters, the recognition or search by the three-dimensional depth image sensor 20 may be added to the recognition or search by the camera 10 to further improve the reliability of the position information of the golf ball and the hole cup. For this purpose, the laser light emitting diode (not shown) of the three-dimensional depth image sensor 20 preferably has high-power performance. According to an embodiment, a high-power laser light emitting diode may be added, and the device may be implemented such that a light-receiving portion (not shown) of the three-dimensional depth image sensor 20 receives strong light reflected from the golf green area.

For example, the computing unit 30 may perform second-order differentiation within or near a hole cup mark HM and a golf ball mark BM based on the three-dimensional depth image data to search for a sharply depressed position and a sharply protruding position, and the computing unit 30 may recognize these positions as the positions of the hole cup C and the golf ball B, respectively. Based further on these positions, the computing unit 30 may calculate at least a distance value between the golf ball B and the hole cup C.

According to an embodiment of an additional aspect, the computing unit 30 may calculate a distance value between the golf ball and the hole cup and a slope between the golf ball and the hole cup based on the three-dimensional depth image data of the determined regions. This enables overcoming the recognition limitations of the three-dimensional depth image sensor (e.g., LiDAR sensor) at distances of approximately 15 meters or more. In general, when measuring with 3D LiDAR, as the measurement distance increases, the spacing between 3D points increases; at distances of 10 to 15 meters, the spacing between points may become too large to accurately recognize the shape of a small hole cup. Additionally, a LiDAR sensor mountable in a compact portable device may have limited resolution due to constraints on size and power consumption. To overcome these problems, the present disclosure adopts an approach of first utilizing the camera image to recognize the positions of the hole cup and the golf ball, and then mapping the position information to the LiDAR data.

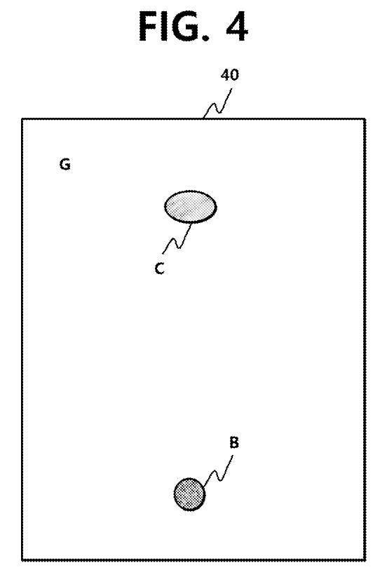

FIG. 4 illustrates an electronic display 40 that is spatially aligned with a field of view aimed by the three-dimensional depth image sensor and displays a two-dimensional image, according to an embodiment. The electronic display 40 may display information of the golf green area G in which the two-dimensional image from the camera 10 and the three-dimensional depth image data from the three-dimensional depth image sensor are spatially aligned. The field of view aimed by the three-dimensional depth image sensor 20 may be displayed on the electronic display 40. The golf green area G may be scanned within a certain area range by the scan operation of the three-dimensional depth image sensor 20.

According to an embodiment, searching for the hole cup C and the golf ball B may be performed simultaneously or in a predefined order. For example, if the path between the golf ball B and the hole cup C is uphill, the golf ball B may be searched first and the hole cup C next; if the path between the golf ball B and the hole cup C is downhill, the hole cup C may be searched first and the golf ball B next.

According to an embodiment, the computing unit 30 may calculate a distance value between the golf ball and the hole cup and a slope between the golf ball and the hole cup based on position information of the golf ball and the hole cup acquired from the three-dimensional depth image sensor 20. The electronic display 40 may display the distance value between the golf ball and the hole cup and the slope between the golf ball and the hole cup in a manner visually perceptible to a user.

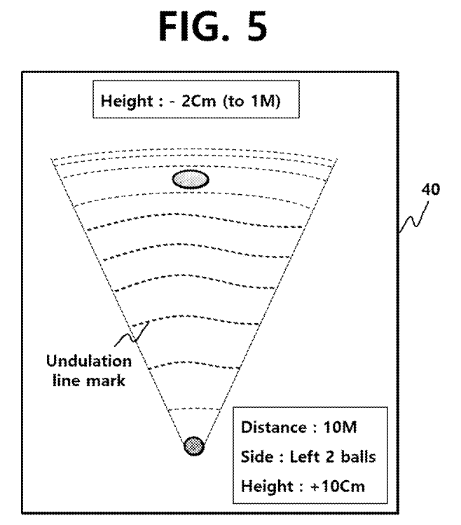

FIG. 5 illustrates an electronic display showing line information of a golf green area in which a golf ball and a hole cup are disposed, according to an embodiment. As illustrated, the electronic display 40 may output line information of the golf green area. The line information of the golf green area may be output by the scan operation of the three-dimensional depth image sensor 20. An undulation line mark may be further displayed on the electronic display 40 to visually provide line information of the green area. Methods for displaying the distance value and the slope may vary. FIG. 5 illustrates, for example, a distance from the golf ball to the hole cup of 10 m, a height from the golf ball to the hole cup of +10 cm (uphill), a slope corresponding to two golf balls to the left from the hole cup, and further provides line information of the green area with a height of −2 cm from the hole cup to 1 m, thereby providing downhill information to the user.

According to an embodiment, the computing unit 30 may control the timing at which the camera 10 takes a snapshot of the golf green area to be synchronized with the timing at which the three-dimensional depth image sensor scans the golf green area. A snapshot refers to the operation by which the camera captures an instantaneous scene to generate a still photograph.

According to an embodiment, the computing unit 30 may further calculate the slope for a region extending from the golf ball, past the hole cup, to a certain distance. This provides more useful information to the user, enabling a more reliable strategy for controlling putting power.

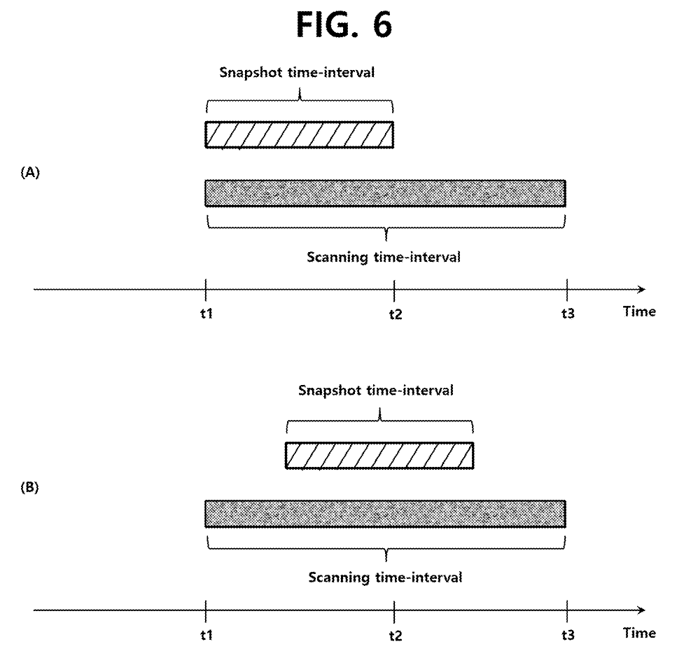

FIG. 6 illustrates a method of synchronizing a snapshot operation of a camera and a scanning operation of a three-dimensional depth image sensor according to an embodiment. FIG. 6(A) illustrates a synchronization method in which the time at which the snapshot operation of the camera starts is identical to the time at which the scanning operation of the three-dimensional depth image sensor starts. FIG. 6(B) illustrates a synchronization method in which the time at which the snapshot operation of the camera starts is later than the time at which the scanning operation of the three-dimensional depth image sensor starts.

A snapshot time interval during which the snapshot operation of the camera is performed and a scanning time interval during which the scanning operation of the three-dimensional depth image sensor is performed may at least partially overlap.

As illustrated in FIG. 6(A), the snapshot time interval during which the snapshot operation of the camera is performed may start at t1, and the scanning time interval during which the scanning operation of the three-dimensional depth image sensor is performed may also start at the same t1. Alternatively, as illustrated in FIG. 6(B), the time at which the snapshot operation of the camera starts may differ from the time at which the scanning operation of the three-dimensional depth image sensor starts; preferably, the time at which the snapshot operation of the camera starts may be later in time than the time at which the scanning operation of the three-dimensional depth image sensor starts.

In this manner, if the timing at which the camera 10 recognizes the positions of the golf ball and the hole cup and the timing at which the three-dimensional depth image sensor 20 recognizes the positions of the golf ball and the hole cup at least partially coincide, the space captured by the camera 10 and the space scanned by the three-dimensional depth image sensor 20 can be made to coincide. This minimizes power consumption of the battery 70 attributable to the three-dimensional depth image sensor 20.

In FIG. 6, the snapshot time interval of the camera is shown as ending at t2 and the scanning time interval of the three-dimensional depth image sensor as ending at a different t3; however, the time intervals may be appropriately adjusted.

The camera 10 captures a single snapshot, but the LiDAR sensor 20 initially acquires 3 to 6 frames (up to 15 or more frames per second) to map data. When the camera 10 is activated, the LiDAR sensor 20 may operate at a minimum product ON mode and then switch to a sleep mode or low-power mode, consuming minimum standby power at all times. When a drive signal is received through the camera or a button, scanning is performed for a minimum of 0.5 to 2 seconds to provide a result; therefore, when using a 1,000 mAh lithium-ion mobile battery, approximately 37 minutes of operation is possible. Assuming one scan per second, including standby current consumption, approximately 1,000 scans may be achievable.

According to an embodiment, the electronic display 40 may be configured as a touch display operated by a touch input of a user. The touch display may be implemented using capacitive, resistive, infrared, or ultrasonic technology, among others.

The computing unit 30 may control the electronic display 40 to display a virtual scan button for initiating a scan operation of the three-dimensional depth image sensor 20 when the electronic display 40 simultaneously displays the golf ball B and the hole cup C.

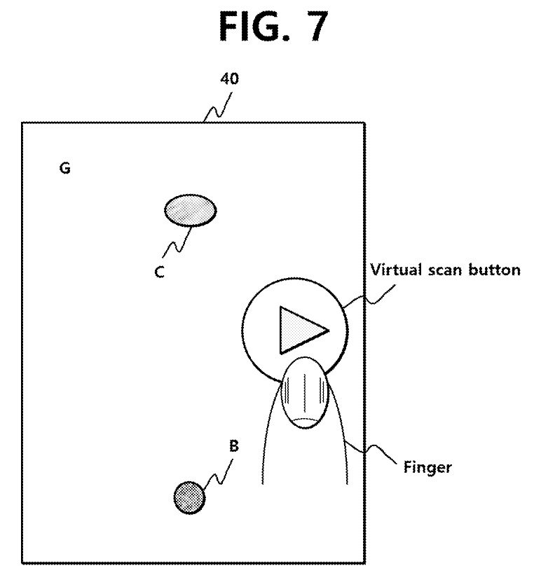

FIG. 7 illustrates an electronic display showing a virtual scan button according to an embodiment. When the golf ball B and the hole cup C are simultaneously displayed on the electronic display 40 and are appropriately displayed for initiating a scan by the three-dimensional depth image sensor 20, the computing unit 30 may control the electronic display 40 to display the virtual scan button. The virtual scan button may be touch-input by the user.

According to an embodiment of an additional aspect, when the electronic display displays a plurality of golf balls simultaneously, the computing unit 30 may control the electronic display to additionally display a virtual ball marker BM so that the user can select one golf ball from among the plurality of golf balls.

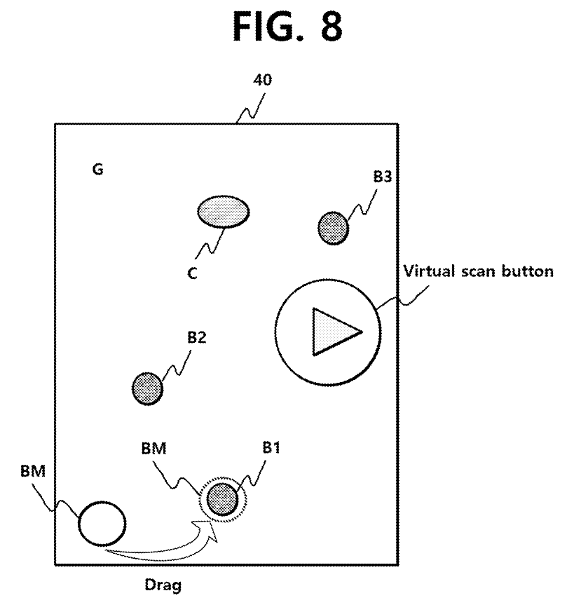

FIG. 8 illustrates an electronic display additionally showing a virtual ball marker according to an embodiment. As illustrated, when a plurality of golf balls B and one hole cup C are simultaneously displayed on the electronic display 40 and are appropriately displayed for initiating a scan by the three-dimensional depth image sensor 20, the computing unit 30 may control the electronic display 40 to additionally display a virtual ball marker BM so that the user can select one golf ball from among the plurality of golf balls. For example, the user may drag the virtual ball marker BM to overlap it with his or her golf ball B1, and the computing unit 30 may calculate golf green information with the golf ball B1 as the reference.

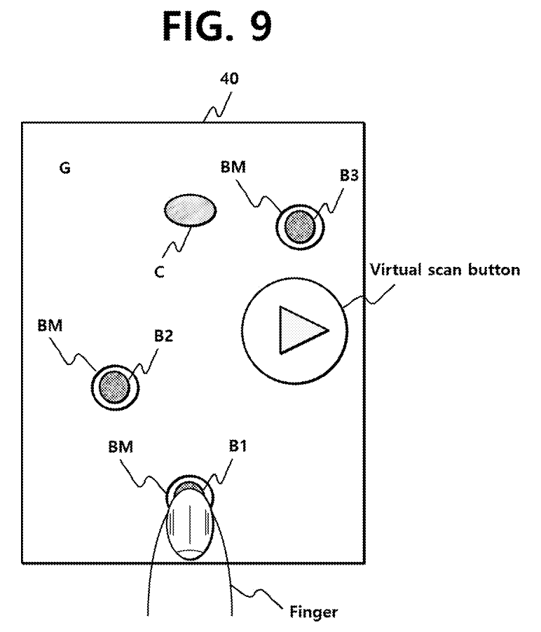

FIG. 9 illustrates an electronic display additionally showing a plurality of virtual ball markers according to another embodiment. As illustrated, when a plurality of golf balls B and one hole cup C are simultaneously displayed on the electronic display 40 and are appropriately displayed for initiating a scan by the three-dimensional depth image sensor 20, the computing unit 30 may control the electronic display 40 to additionally display a plurality of virtual ball markers BM respectively overlapping with each of the plurality of golf balls B1, B2, and B3, so that the user can select one golf ball from among the plurality of golf balls. The user may touch his or her golf ball B on the electronic display 40 with a finger, and the computing unit 30 may calculate a distance value between the selected golf ball and the hole cup and a slope between the selected golf ball and the hole cup based on the golf ball selected by the user from among the plurality of golf balls.

According to another embodiment, when golf balls belonging to other players are also displayed on the electronic display 40 along with the user's own ball, the LiDAR sensor 20 may be activated using the scan button to scan the green area, and after the scan, each of the plurality of golf balls displayed on the electronic display 40 may be individually touched to calculate the distance and slope for each respective golf ball.

According to an embodiment, the computing unit 30 may control a virtual simulation button for a putting simulation to be additionally displayed on the electronic display 40. When a touch input from the user is received on the simulation button, the computing unit 30 may control a virtual trajectory of the golf ball to be additionally displayed on the electronic display 40.

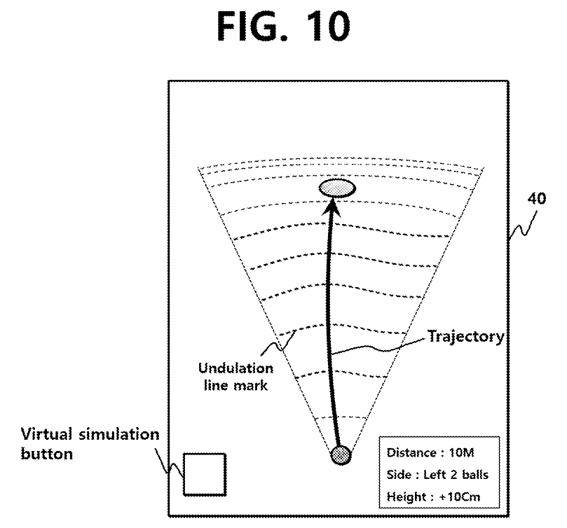

FIG. 10 illustrates an electronic display additionally showing a simulation button and a virtual trajectory of a golf ball according to an embodiment. When the distance value between the golf ball and the hole cup and the slope between the golf ball and the hole cup are displayed on the electronic display 40 and the user touches the virtual simulation button, a virtual trajectory of the golf ball may be additionally displayed on the electronic display 40.

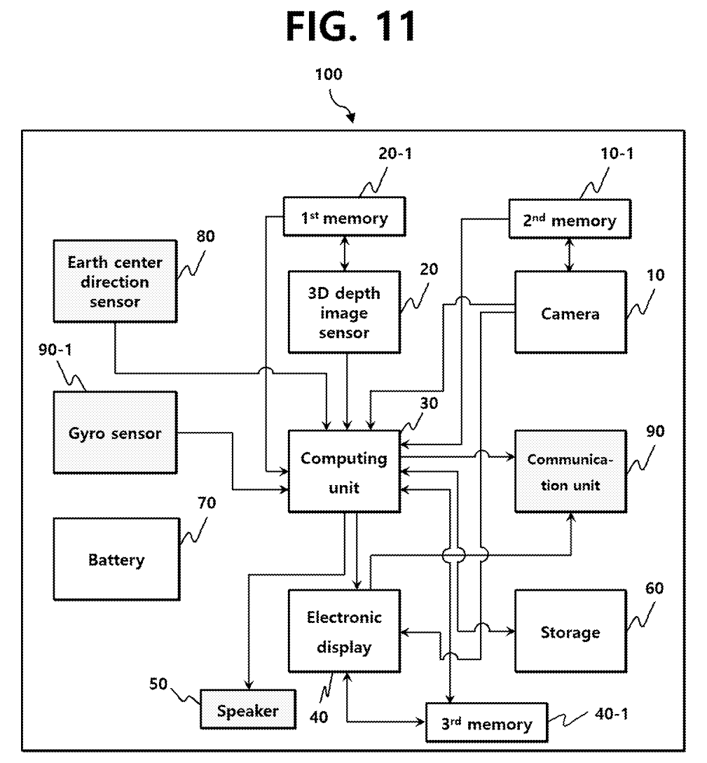

According to an embodiment of an additional aspect, the portable green information providing device 100 may further include an Earth center direction sensor 80 configured to output an Earth center direction vector. FIG. 11 is a block diagram illustrating a configuration of the portable green information providing device according to another embodiment. FIG. 11 further shows a speaker 50, an Earth center direction sensor 80, a communication unit 90, and a gyro sensor 90-1 in addition to the block diagram of FIG. 2.

The Earth center direction sensor 80 measures the Earth center direction vector, detects the direction toward the Earth center in the portable green information providing device 100, and outputs it. As a result, posture information of the portable green information providing device 100 with respect to the golf ball and the hole cup is acquired, and the computing unit 30 can calculate the distance value and slope therefrom. In an embodiment, the Earth center direction sensor 80 may be an acceleration sensor. The acceleration sensor may output the Earth center direction vector when the sensor carrier is not undergoing acceleration.

According to another embodiment, the Earth center direction sensor 80 may be a composite sensor including an Inertial Measurement Unit (IMU) sensor that is widely used to detect the position, velocity, and direction of an object by measuring acceleration and angular velocity. The Earth center direction sensor 80 may or may not be integrated with the three-dimensional depth image sensor 20.

The portable green information providing device 100 may include the speaker 50 configured to further output the calculated distance value and slope as voice. When the hole cup and the golf ball are sensed by the portable green information providing device 100 and the slope is calculated, there may be users for whom it is more convenient to have the line information output as a brief verbal announcement rather than displayed visually. The line information may be output as voice through the speaker 50.

The portable green information providing device 100 may further include a communication unit 90. The communication unit 90 may provide a function enabling the portable green information providing device 100 to perform data communication with the external smartphone 200 or earset 300 via Wi-Fi or Bluetooth (BT) communication. The communication unit 90 may be configured as a short-range communication module such as a Wi-Fi module and/or a BT module, or may be configured as a broadband communication module for communication with an external server.

The portable green information providing device 100 may further include a gyro sensor 90-1. The gyro sensor 90-1 may detect shakiness of the portable green information providing device 100 and perform an image stabilization function. For example, Optical Image Stabilization (OIS), Digital Image Stabilization (DIS), or Electronic Image Stabilization (EIS) may be further provided to prevent blurring of the image. Through this, minute movements in directional variation that may occur when the user uses the portable green information providing device 100 can be detected by measuring Roll, Pitch, and Yaw angles and corrected, thereby enabling more accurate distance measurement.

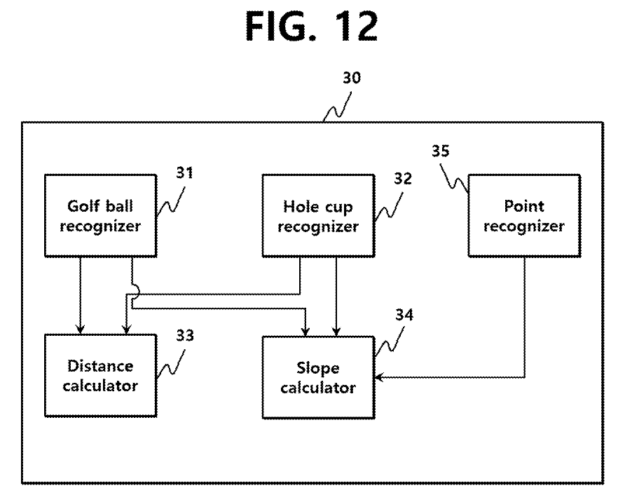

FIG. 12 is a block diagram illustrating a configuration of the computing unit according to an embodiment. As illustrated, the computing unit according to an embodiment may include a golf ball recognizer 31, a hole cup recognizer 32, a distance calculator 33, and a slope calculator 34, and may further include a point recognizer 35 according to an additional aspect.

The golf ball recognizer 31 may search for and recognize a golf ball from the two-dimensional image of the golf green area or the three-dimensional depth image data of the golf green area. For example, the golf ball recognizer 31 may recognize the golf ball from the two-dimensional image of the golf green area generated by the camera 10, or may perform second-order differentiation on the three-dimensional depth image data generated by the three-dimensional depth image sensor 20 to search for a sharply depressed position and a sharply protruding position, and recognize that position as the position of the golf ball B.

The hole cup recognizer 32 may search for and recognize a hole cup from the two-dimensional image of the golf green area or the three-dimensional depth image data of the golf green area. For example, the hole cup recognizer 32 may recognize the hole cup C from the two-dimensional image of the golf green area generated by the camera 10, or may perform second-order differentiation on the three-dimensional depth image data generated by the three-dimensional depth image sensor 20 to search for a sharply depressed position and a sharply protruding position, and recognize that position as the position of the hole cup C.

The distance calculator 33 may calculate a distance value between the recognized hole cup and the recognized golf ball using the Earth center direction vector measured by the Earth center direction sensor and the three-dimensional depth image data of the golf green area generated by the three-dimensional depth image sensor.

The slope calculator 34 may calculate a slope between the recognized hole cup and the recognized golf ball using the Earth center direction vector measured by the Earth center direction sensor and the three-dimensional depth image data of the golf green area generated by the three-dimensional depth image sensor.

According to an embodiment of an additional aspect, the computing unit 30 may further include a point recognizer 35. The point recognizer 35 may recognize a plurality of points from at least the golf ball to the hole cup. The slope calculator 34 may calculate a surrounding slope for each of the plurality of points P from the golf ball B to the hole cup C, and calculate a slope for each interval between adjacent points P.

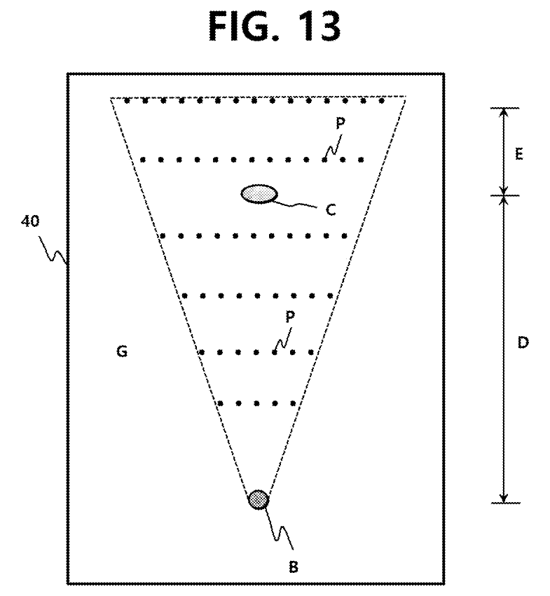

FIG. 13 illustrates a plurality of points recognized by the point recognizer according to an embodiment. As illustrated, the point recognizer 35 extracts a plurality of points from sensing points sensed by the three-dimensional depth image sensor, at least from the golf ball to the hole cup. For example, the plurality of points P may be points existing within a partial region of the green area G set as an inverted triangle region with the hole cup mark HM and the golf ball mark BM on a center line, and the slope of each point may be individually calculated. The slope may be the surrounding slope of the point, for example, the slope in the front, back, left, and right directions of the point.

The positions of the plurality of points P may be preset in the camera 10. The preset number of points P may range from tens of thousands to hundreds of thousands, but is not limited thereto. Too many points may increase the time required for calculation, and too few points may reduce the accuracy of the information; therefore, an appropriate number and arrangement of points may be set.

Unlike the hole cup mark HM and the golf ball mark BM, the plurality of points P may not be shown to the user on the electronic display 40. By extracting only some of the sensing points sensed by the three-dimensional depth image sensor and calculating the slope, the time required for calculation can be reduced. The slope calculator 34 of the computing unit 30 may calculate the front, back, left, and right slopes for the plurality of points from the golf ball to the hole cup, and calculate the slope for each interval between adjacent points.

Although the present disclosure has been described through the embodiments with reference to the accompanying drawings, the present disclosure is not limited thereto and should be interpreted to encompass various modifications that can be obviously derived by a person skilled in the art. The claims are intended to encompass such modifications.

What is claimed is:

1. A portable green information providing device for providing line information of a golf green area in which a golf ball and a hole cup are disposed, the device comprising:
a camera configured to capture the golf green area, generate a two-dimensional image of the golf green area, and recognize positions of the golf ball and the hole cup; and
a three-dimensional depth image sensor configured to scan the golf green area and generate three-dimensional depth image data of the golf green area,
wherein the camera captures the golf green area that is spatially calibrated with respect to the golf green area captured by the three-dimensional depth image sensor to generate the two-dimensional image of the golf green area,
wherein the portable green information providing device further comprises:
a computing unit configured to control generation of mapped golf green area information by spatially mapping the two-dimensional image from the camera with the three-dimensional depth image data from the three-dimensional depth image sensor; and
an electronic display configured to display the mapped golf green area information as a two-dimensional image.

2. The portable green information providing device of claim 1, wherein the three-dimensional depth image sensor is a LiDAR sensor.

3. The portable green information providing device of claim 1, wherein the computing unit is further configured to:
determine three-dimensional depth image data corresponding to regions in the two-dimensional image where the golf ball and the hole cup are recognized; and
process the three-dimensional depth image data of the determined regions.

4. The portable green information providing device of claim 3, wherein the computing unit is further configured to calculate at least a distance value between the golf ball and the hole cup and a slope between the golf ball and the hole cup, further based on position information of the golf ball and the hole cup acquired from the three-dimensional depth image sensor.

5. The portable green information providing device of claim 3, wherein the computing unit is further configured to calculate a distance value between the golf ball and the hole cup and a slope between the golf ball and the hole cup based on the three-dimensional depth image data of the determined regions.

6. The portable green information providing device of claim 3, wherein the electronic display is further configured to display the distance value between the golf ball and the hole cup and the slope between the golf ball and the hole cup in a manner visually perceptible to a user.

7. The portable green information providing device of claim 3, wherein the computing unit is further configured to synchronize a timing at which the camera takes a snapshot of the golf green area with a timing at which the three-dimensional depth image sensor scans the golf green area.

8. The portable green information providing device of claim 3, wherein:
the electronic display comprises a touch display operated by a touch input of a user; and
the computing unit is further configured to control the electronic display to display a virtual scan button for initiating a scan operation of the three-dimensional depth image sensor when the electronic display simultaneously displays the golf ball and the hole cup.

9. The portable green information providing device of claim 8, wherein the computing unit is further configured to control the electronic display to additionally display a virtual ball marker so that a user can select one golf ball from among a plurality of golf balls when the electronic display simultaneously displays the plurality of golf balls.

10. The portable green information providing device of claim 9, wherein the computing unit is further configured to calculate a distance value between the selected golf ball and the hole cup and a slope between the selected golf ball and the hole cup, based on the golf ball selected by the user from among the plurality of golf balls.

11. The portable green information providing device of claim 10, wherein the computing unit is further configured to:
control the electronic display to additionally display a virtual simulation button for a putting simulation; and
control the electronic display to additionally display a virtual trajectory of the golf ball when a touch input from the user is received on the simulation button.

12. The portable green information providing device of claim 1, further comprising:
an Earth center direction sensor configured to output an Earth center direction vector.

13. The portable green information providing device of claim 12, wherein the computing unit comprises:
a golf ball recognizer configured to search for and recognize a golf ball from the two-dimensional image of the golf green area or the three-dimensional depth image data of the golf green area;
a hole cup recognizer configured to search for and recognize a hole cup from the two-dimensional image of the golf green area or the three-dimensional depth image data of the golf green area;
a distance calculator configured to calculate a distance value between the recognized hole cup and the recognized golf ball using the Earth center direction vector measured by the Earth center direction sensor and the three-dimensional depth image data of the golf green area generated by the three-dimensional depth image sensor; and
a slope calculator configured to calculate a slope between the recognized hole cup and the recognized golf ball using the Earth center direction vector measured by the Earth center direction sensor and the three-dimensional depth image data of the golf green area generated by the three-dimensional depth image sensor.

14. The portable green information providing device of claim 13, wherein the computing unit further comprises:
a point recognizer configured to recognize a plurality of points from at least the golf ball to the hole cup,
wherein the slope calculator is further configured to calculate a surrounding slope for each of the plurality of points from the golf ball to the hole cup and to calculate a slope for each interval between adjacent points.
